(19) United States
(12) Patent Application Publication
(10) Pub. No.: US 2016/0026936 A1
(43) Pub. Date: Jan. 28, 2016

(54) EVENT-BASED RIDESHARING

(71) Applicant: Facebook, Inc., Menlo Park, CA (US)

(72) Inventors: Mark A. Richardson, Seattle, WA (US); Alexandru Petrescu, Shoreline, WA (US); Michael Adam Finch, Seattle, WA (US)

(21) Appl. No.: 14/341,289

(22) Filed: Jul. 25, 2014

(51) Int. Cl. G06Q 10/02

(52) U.S. Cl. CPC G06Q 10/02; G06Q 50/01

(57) ABSTRACT

Exemplary methods, apparatuses, and systems present, to a first user of a network service, a description of an event, a selectable option for the first user to indicate an intention to attend the event, and an indication of users of the network service that intend to attend the event. An indication that the first user intends to attend the event and a set of one or more users the first user is willing to take as passengers to the event are received. An indication that a second user of the network service intends to attend the event is also received. The first user is presented as a potential driver to the second user in response to receiving the indication that the second user intends to attend the event and determining the second user is within the set of one or more users.

### FIELD

The various embodiments described herein relate to ridesharing. In particular, the embodiments relate to facilitating ridesharing between users of a network service to events published within the network service.

### BACKGROUND

Social networking systems enable users to interact with various objects represented within the social network. For example, a social networking system allows users to designate other users or entities as connections (or otherwise connect to, or form relationships with, other users or entities), contribute and interact with their connections, post media or commentary, share links to external content, use applications, join groups, indicate intended attendance at events, invite connections, and perform other tasks that facilitate social interaction. External applications also use the services of a social networking system to allow authenticated users to incorporate some of the above social interactions with use of the external applications. Similar interactions may also be a part of the user experience within other network services.

### SUMMARY OF THE DESCRIPTION

Exemplary methods, apparatuses, and systems present an event to users of a social network or other network service. The event includes a description of the event, such as a date, a location, event details, an indication of users of the network service that intend to attend the event, etc. The presentation of the event includes one or more selectable options for each user, including options to indicate an intention to attend and drive to the event or to indicate an intention to attend and not drive to the event. The indication that the user intends to attend the event and drive/not drive is received and used to facilitate ridesharing.

If the user is driving to the event, embodiments receive ridesharing information for the driver. For example, the user may indicate a maximum number of passengers the user is willing to take to the event, a set of users that may be matched with the driver for a rideshare, a departure location, a threshold distance or location the user is willing to travel to pick up a passenger, an earliest departure time, etc. If the user is seeking a ride, embodiments receive ridesharing information for the passenger. For example, the user indicates a set of users that may be matched as a driver for a rideshare, a departure location, an earliest departure time, etc.

Upon receiving indications that users intend to attend the event, embodiments determine and present a match for a rideshare. For example, a first user may be presented as a potential driver to a second user in response to determining a match between the first and second users based upon the received ridesharing information. Similarly, the second user may be presented as a potential passenger to the first user in response to determining a match between the users based upon the received ridesharing information. If one user selects the other user (as a driver/passenger), embodiments transmit a notification of the selection to the other user.

In one embodiment, non-driving users are presented with an option to coordinate travel with one or more other users via public transit. For example, if two users indicate that they plan to attend an event and travel to the event via a train line, bus line, taxi, etc., embodiments may facilitate the two users travelling together on the same train or bus, sharing a taxi, etc.

In one embodiment, location data from users is used to determine a ridesharing route. Exemplary location data includes an indicated departure location received from the user, a current position shared by a user's mobile device, an estimated location based upon user activity, etc. Additionally, an estimated travel time may be calculated based upon the determined route. Using the estimated travel time, embodiments alert the driver of a need to depart. In one embodiment, embodiments receive an indication the driver is departing and presents driving directions to the driver. Additionally, embodiments provide notifications to the passenger(s), e.g., of when the driver departs, when the driver picks up another passenger, when the driver is approaching, an estimated pick up time, etc.

In one embodiment, ridesharing users are presented with advertising based upon the event and/or ridesharing. For example, a driver may be presented with an advertisement for a parking garage located in close proximity to the location of the event.

Other features and advantages will be apparent from the accompanying drawings and from the detailed description.

### BRIEF DESCRIPTION OF THE DRAWINGS

The present invention is illustrated by way of example and not limitation in the figures of the accompanying drawings, in which like references indicate similar elements, and in which:

FIG. 1 illustrates an exemplary network environment of a system, including a social networking system, to facilitate event-based ridesharing;

FIG. 2 illustrates an exemplary graph of social network data used to suggest users for event-based ridesharing;

FIG. 3 is a flow chart illustrating an exemplary method to facilitate event-based ridesharing;

FIG. 4 is an exemplary user interface illustrating an event and options for users to indicate intentions to attend and drive to an event or attend and not drive to the event;

FIG. 5 is an exemplary user interface illustrating a form to receive ridesharing information;

FIG. 6 is an exemplary user interface illustrating selectable options for a user that intends to attend but not drive to an event;

FIG. 7 is an exemplary user interface illustrating determined matches for ridesharing;

FIG. 8 is a flow chart illustrating another exemplary method to facilitate event-based ridesharing;

FIG. 9 is an exemplary user interface to enable a driver to indicate a departure to pick up one or more passengers;

FIG. 10 is an exemplary user interface illustrating a route map presented to the driver; and

FIG. 11 illustrates, in block diagram form, an exemplary processing system to facilitate event-based ridesharing.

### DETAILED DESCRIPTION

Embodiments described herein allow users of a social network or other network service to respond to a published invitation to an event with ridesharing information. As a result, users are not only able to confirm that they plan to attend the event, but are also matched with other users based upon the ridesharing information. Matched users are able to benefit from cost effective, environmentally friendly, and/or social aspects of sharing transportation to the event.

In the following description, numerous specific details are set forth. However, it is understood that embodiments of the invention may be practiced without these specific details. While a social networking system is used to describe embodiments of facilitating event-based ridesharing between users, it will be understood that these concepts are generally applicable to facilitating event-based ridesharing between users of other network services/entities, websites, etc. References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Additionally, as used herein, the term “exemplary” refers to embodiments that serve simply as an example or illustration. Furthermore, when a particular feature, structure, or characteristic is described in connection with an embodiment, it is submitted that it is within the knowledge of one skilled in the art to affect such feature, structure, or characteristic in connection with other embodiments whether or not explicitly described.

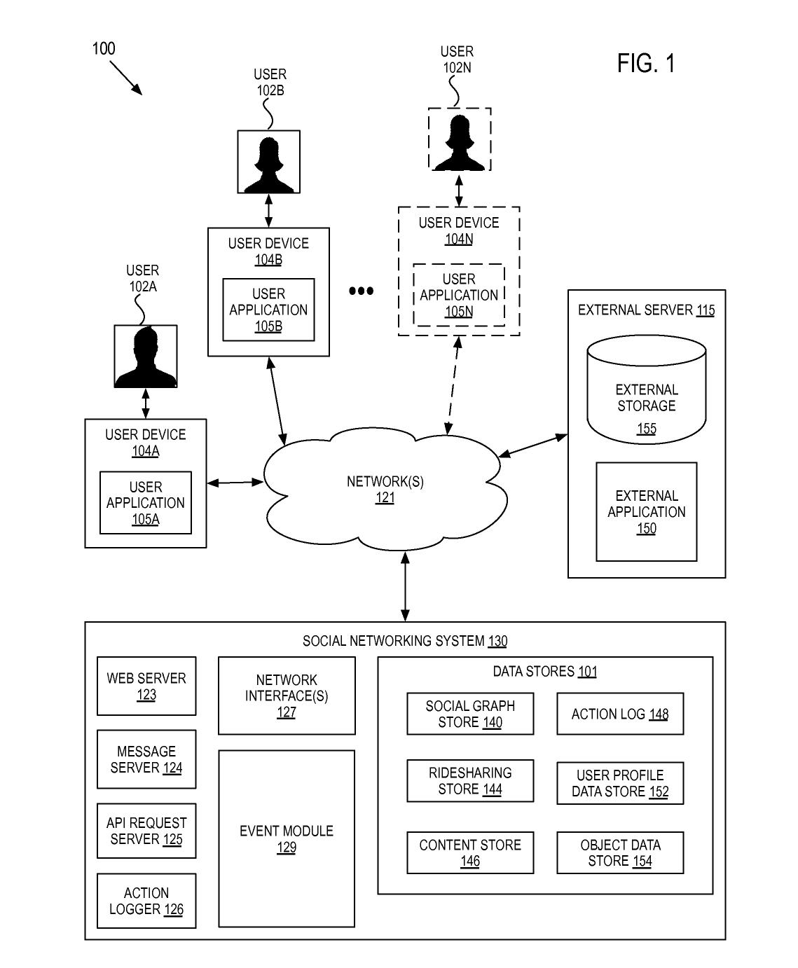

FIG. 1 illustrates an exemplary network environment of a system 100, including a social networking system 130, to facilitate event-based ridesharing between users 102A-102N. The user devices 104A-104N are enabled to interact with social networking system 130 and can be any type of computing device capable of receiving user input as well as transmitting and/or receiving data via a network (e.g., network(s) 121). Exemplary user devices 104A-104N include conventional computer systems, such as a desktop or laptop computer, or may include devices having computer functionalities such as Personal Digital Assistants (PDA), cellular or mobile telephones, smart-phones, in- or out-of-car navigation systems, gaming devices, or other electronic devices.

In one embodiment, a user device (e.g., 104A) may execute a user application (e.g., 105A) allowing a user 102A of the user device 104A to interact with the social networking system 130. For example, the user application 105A may be a web browser application. In an embodiment, the user application 105A is a special-purpose client application (e.g., Facebook for iPhone or iPad, etc.), and in an embodiment the user application 105A is the native operating system of the user device 104A, which may utilize an Application Programming Interface (API) to directly interface with the social networking system 130 through API request server 125.

The user devices 104A-104N are configured to communicate with the social networking system 130 via a network 121 or collection of networks, such as the Internet, a corporate Intranet, a Virtual Private Network (VPN), a Local Area Network (LAN), a Wireless Local Area Network (WLAN), a cellular network, a Wide Area Network (WAN), a Metropolitan Area Network (MAN), or a combination of two or more such networks. The network 121 may be wired, wireless, or a combination of both. In one embodiment, the network 121 uses standard communications technologies and/or protocols.

In some embodiments, the social networking system 130 comprises one or more computing devices storing user profiles associated with users 102A-102N and/or other objects, as well as connections between users and other users 102A-102N and/or objects. Users 102A-102N, using the social networking system 130, may add connections to other users or objects of the social networking system 130 to which they desire to be connected, and may also interact with these other users or objects. The users of the social networking system 130 are individuals (e.g. humans), and the objects may include entities (such as businesses, organizations, universities, manufacturers, brands, celebrities, etc.), concepts, or other things including but not limited to a location, an album, an article, a book, a movie, food, etc.

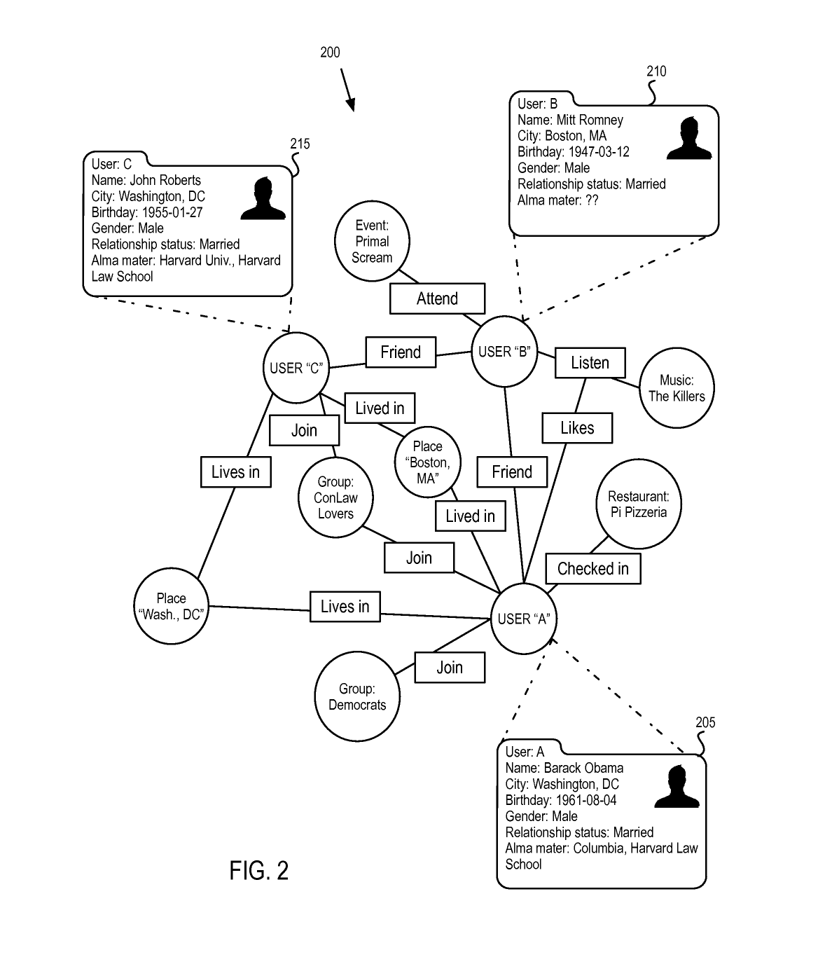

Based on the stored data about users, objects, and the connections between the users and/or objects, the social networking system 130 generates and maintains a “social graph” in a social graph store 140 comprising a plurality of nodes interconnected by a plurality of edges. Each node in the social graph represents a user or object that can act on another node and/or that can be acted on by another node. An edge between two nodes in the social graph represents a particular kind of connection between the two nodes, which may result from an action that was performed by one of the nodes on the other node. For example, when a user identifies an additional user as a friend, an edge in the social graph is generated connecting a node representing the first user and an additional node representing the additional user. The generated edge has a connection type indicating that the users are friends. As various nodes interact with each other, the social networking system 130 adds, removes, or otherwise modifies edges connecting the various nodes to reflect the interactions. An exemplary social graph is described with reference to FIG. 2.

To provide these functionalities, one embodiment of the social networking system 130 includes an API request server 125, a web server 123, a message server 124, an action logger 126, and a set of data stores 101. This embodiment also includes, within the data stores 101, a social graph store 140, a ridesharing store 144, a content store 146, an action log 148, a user profile data store 152, and an object data store 154. In other embodiments, the social networking system 130 may include additional, fewer, or different modules for various applications. Of course, conventional components such as processors, memories, security mechanisms, load balancers, failover servers, management and network operations consoles, and the like are not shown in FIG. 1 so as to not obscure the details of the system.

The social networking system 130 allows its users 102A-102N to communicate or otherwise interact with each other and access content, as described herein. The social networking system 130 stores user profiles in the user profile data store 152. A user profile includes declarative information about the user that was explicitly shared by the user, and may also include profile information inferred by the social networking system 130. In one embodiment, a user profile includes multiple data fields, each data field describing one or more attributes of the corresponding user of the social networking system 130. The user profile information stored in user profile data store 152 describes the users 102A-102N of the social networking system 130, including biographic, demographic, and other types of descriptive information, such as work experience, educational history, gender, relationship status, hobbies, location, other preferences, and the like. The user profile may also store information provided by the user. For example, images, videos, and location data provided by the user may also be stored within the user profile. In other embodiments, only textual data of the user is stored in the user profile and other data (e.g., images, videos, etc.) are stored in multimedia stores and associated with the user (e.g., through associating a user identifier of the user with an image/video identifier of the multimedia content). In certain embodiments, images, videos, and posts by users including or depicting one or more other users of the social networking system 130 may be “tagged” with identification information of those users. A user profile in the user profile data store 152 may also maintain references to actions (stored in the user profile or in an action log 148) by the corresponding user performed on content items in a content store 146. A user may also specify one or more privacy settings, which are stored in that user's user profile. Privacy settings limit information that the social networking system 130 or other users of the social networking system 130 are permitted to access from that user's user profile.

The web server 123 links the social networking system 130 via the network 121 to one or more user devices 104A-104N by accepting requests for from the user devices 104A-104N and/or transmitting webpages or other web-related content to the user devices 104A-104N, such as image files, audio files, video files, Java applets, Flash, XML, JavaScript, Cascading Style Sheets (CSS), and so forth. The web server 123 in some embodiments is configured to utilize a set of one or more network interfaces 127 to send and receive messages across the network 121. In some embodiments the web server 123 (additionally or alternately) utilizes a message server 124 (e.g., a dedicated server end station, a dedicated software application, etc.) to communicate with the user devices 104A-104N, which is operative to send and/or receive instant messages, queued messages (e.g., email), text and SMS (Short Message Service) messages, or utilize any other suitable messaging technique.

In some embodiments, a message sent by a user to another user by way of the social networking system 130 can be viewed by other users of the social networking system 130, for example, by certain connections of the user (directly connected users in the social graph, other users more than one hop away in the social graph, etc.) receiving the message. An example of a type of message that can be viewed by other users of the social networking system 130 (besides the recipient of the message) is commonly known as a “post.” In some embodiments, a user can send a private message to another user that can only be retrieved by the other user.

When a user takes an action within the social networking system 130, an action logger 126, subject to any privacy settings and restrictions of the user and/or social networking system 130, may record the action in an action log 148. In one embodiment, the social networking system 130 maintains the action log 148 as a database of entries. When an action is taken on the social networking system 130, the social networking system 130 can add an entry for that action to the action log 148. In accordance with various embodiments, the action logger 126 is capable of receiving communications from the web server 123 about user actions on and/or off the social networking system 130. The action logger 126 populates the action log 148 with information about those user actions. This information may be subject to privacy settings associated with the user. Any action that a particular user takes with respect to another user is associated with each user's profile, through information maintained in a database or other data repository, such as the action log 148. Examples of actions taken in the social networking system 130 that may be stored in the action log 148 include, but are not limited to, adding a connection to another other user, sending a message to the other user, reading a message from the other user, viewing content (e.g., posts, images, videos) associated with or created by the other user, attending an event posted by another user, being tagged in posts or photos with/by another user, giving a gift to another user, etc. As used herein, “attending an event” and “indicating that the user intends to attend an event” are used interchangeably.

Users may interact with various objects on the social networking system 130, including viewing posts, commenting on posts, sharing links, checking-in to physical locations via a mobile device, and other interactions. Information describing these actions is stored in the action log 148. Additional examples of interactions with objects on the social networking system 130 included in the action log 148 include logging in to the social networking system 130, commenting on a photo album, communications between users, becoming a fan of a musician or brand by “liking” a page of the respective entity, adding an event to a calendar, joining a group, creating/attending an event, authorizing an application, using an application, and engaging in a transaction. Additionally, the action log 148 records a user's interactions with advertisements on the social networking system 130 as well as other applications operating on the social networking system 130. In some embodiments, data from the action log 148 is used to infer interests or preferences of the user, augmenting the interests included in the user profile and allowing a more complete understanding of user preferences.

The action log 148 may be used by the social networking system 130 to track other user actions on the social networking system 130, as well as actions on an external application 150 (e.g., website) that are communicated to the social networking system 130. For example, the social networking system 130 may allow users to interact with external (e.g., third-party) applications 150 (e.g., websites), external storage 155, and/or external servers 115 (e.g., server end stations). The API request server 125 allows external systems (e.g., an external application 150 of external server 115, and/or user applications 105A of user devices 104A-104N) to access information from or transmit information to the social networking system 130 by issuing API calls. The information provided by the social networking system 130 may include user profile information or the connection information of users, subject to the individual privacy settings of the user. For example, a system (e.g. external application 150) may send an API request to the social networking system 130 via the network 121 to publish a story on behalf of the user, request information about a user (after having been given permission to do so by the user), upload a photograph on behalf of a user, etc. API requests are received at the social networking system 130 by the API request server 125, which then processes the request by performing actions sought by the API requests, determining appropriate responses to the API requests, and transmitting back these responses back to the requesting application 150 via the network 121.

The content store 146 stores content items associated with user profiles, such as images, videos, and/or audio files. Content items from the content store 146 may be displayed when a user profile is viewed or when other content associated with the user profile is viewed. For example, displayed content items may show images or video associated with a user profile or show text describing a user's status. Additionally, other content items may facilitate user engagement by encouraging a user to expand his connections to other users or entities, to invite new users to the system or to increase interaction with the social network system 130 by displaying content related to users, objects, activities, or functionalities of the social networking system 130. Examples of social networking content items include suggested connections or suggestions to perform other actions, media provided to or maintained by the social networking system 130 (e.g., pictures, videos), status messages or links posted by users to the social networking system, events, groups, pages (e.g., representing an organization or commercial entity), and any other content provided by, or accessible via, the social networking system 130.

The content store 146 also includes one or more pages associated with entities included social graph store 140. An entity is a type of object that can be a non-individual user of the social networking system 130, such as a business, a vendor, an organization, or a university. However, in some embodiments of the invention, an entity may represent a celebrity or other well-known individual, and thus an entity object node for a person may exist in the social graph (serving as a “brand” for that individual, and perhaps having an associated page that other users may “like”) and also a user node for that same person may also exist in the social graph (serving as a representation for a personal account of that person). A page includes content associated with an entity and instructions for presenting the content to a user of the social networking system 130. For example, a page identifies content associated with the entity's stored content (from the object data store 154) as well as information describing how to present the content to users viewing the page.

In the depicted embodiment, social networking system 130 includes an event module 129. In an alternate embodiment, the event module 129 is a part of the external server 115. For example, the event module 129 may be implemented by the external application 150. The event module 129 facilitates event-based ridesharing as described herein, e.g., with respect to FIGS. 2-10. For example, the event module 129 receives ridesharing information from users and determines matches between users based upon the ridesharing information. In one embodiment, the event module 129 creates and/or maintains a data structure to store, in the ridesharing store 144, the ridesharing information and matches for users.

FIG. 2 illustrates exemplary graph 200 of social network data. In graph 200, objects are illustrated as circles and actions are illustrated as labeled connections between circles. Developers of the social network or corresponding social network applications define actions to represent different ways that users may interact with the social network and/or their applications. As users perform actions, connections are made between users and objects. For example, User A has performed a number of actions within the social network, indicating that he previously lived in Boston, currently lives in Washington D.C., joined groups for Democrats and ConLaw Lovers, checked in at Pi Pizzeria in St. Louis, Mo., and is friends with User B. User B and User C have also performed a number of actions with respect to objects within graph 200.

In one embodiment, users are able to add demographic information to user profiles 205-215. In one embodiment, for demographic information that has not been entered by a user, a social network application generates an estimate based upon the user's actions, connections, and/or actions of connections. For example, User B has not entered an alma mater into user profile 210. A social network application may determine from User B's contacts, activities, cities of residence, etc. that User B's likely alma mater is one or both of Brigham Young University and Harvard University. In one embodiment, the user profiles 205-210 include additional information, such as relationships to other users, places where the user has worked, user interests, etc.

In one embodiment, users are able to provide feedback on actions of other users/entities. As a result, actions are also viewed as objects that may be acted upon. For example, User B listened to music by the artist, The Killers. As a result, the social networking system publishes a narrative associated with User B (e.g., in a newsfeed, profile of User B, etc.) indicating that User B listened to music by the artist, The Killers. In viewing a newsfeed, profile of User B, or another form of social networking system publication(s), the social networking system displays the narrative to User A. The social networking system then receives input from User A indicating that User A “likes” that User B listened to The Killers.

In one embodiment, demographic data further includes a weight or score indicating an affinity between a user and an object. For example, repeated user action with one object may indicate a stronger affinity for said object than another object with which the user has limited interaction. First degree connections, e.g., the friendship between User A and User B, may indicate a stronger affinity than second degree connections, e.g., User A is friends with User B, who is friends with User C, creating a second degree connection between User A and User C. An indication that two users are married may indicate a stronger affinity than if two users are friends. Additionally, temporal and geographic proximity of actions/users are other exemplary indicators of affinity.

In one embodiment, the event module 129 utilizes user characteristics stored in the graph 200 to determine event-based ridesharing matches as described in greater detail herein. In one embodiment, users may select privacy settings to control what network service data is shared, with whom the data is shared, and/or what data used by event module 129.

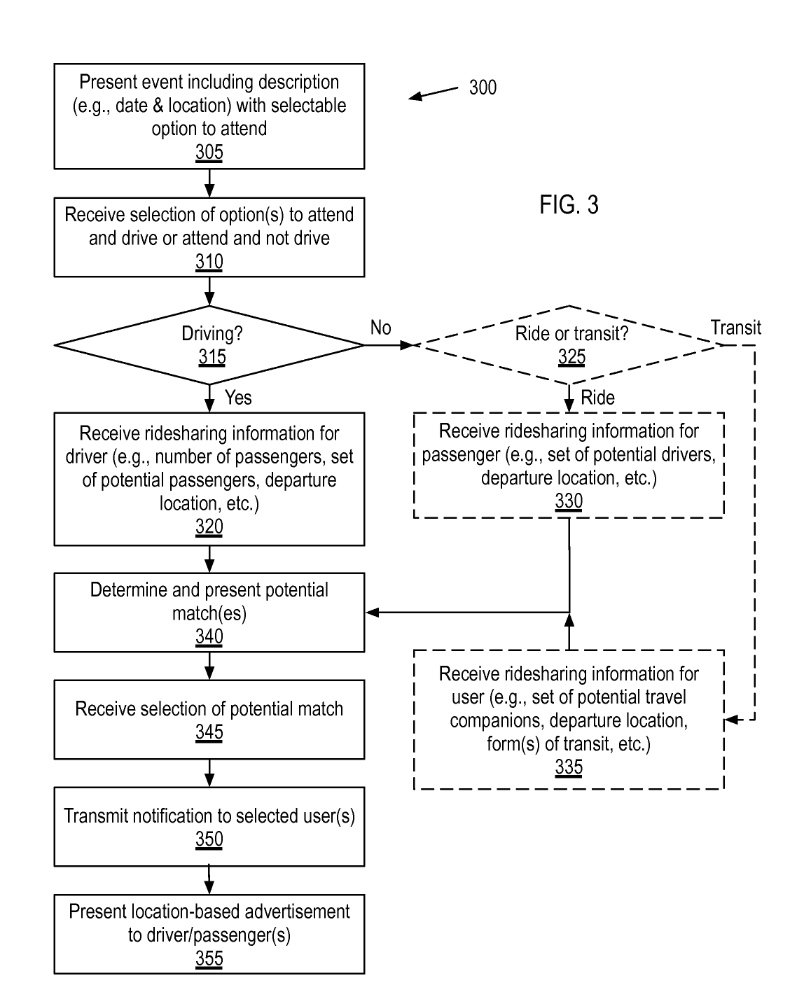

FIG. 3 is a flow chart illustrating an exemplary method 300 to facilitate event-based ridesharing. At block 305, event module 129 presents an event to a user. For example, user device 104A executes application 105A enabling user 102A to view an event published within a portal of the social networking system 130. The event includes a description and one or more selectable options for the user to indicate intent to attend the event. The description includes a date and location of the event. In one embodiment, the description further includes one or more of a time of the event, an image associated with the event, a map of the event location, an indication of users invited to the event, users that have indicated intent to attend the event, descriptive details about the event, etc.

At block 310, event module 129 receives a selection of one or more options (or other input) indicating the user intends to attend the event and whether or not the user will drive to the event. In one embodiment, the options presented enable the user to select a single option to indicate intent to attend and drive or another single option to indicate intent to attend and not drive. In another embodiment, the attendance and driving options are presented separately. For example, the user selects an option to indicate intent to attend and another option to indicate whether or not the user plans to drive. In yet another embodiment, the user provides the input indicating the user intends to attend the event and whether or not the user will drive to the event in another format, e.g., by filling out a form.

At block 315, event module 129 determines whether or not the user plans to drive to the event based upon the user selection/input. If the user plans to drive, at block 320, event module 129 receives ridesharing information for the user as a driver. For example, event module 129 presents a request for the driver to select or otherwise provide input indicating one or more of the following: how many passengers the driver is willing to drive to the event; if a particular set of users within the social network should see an invitation to ride with the driver or otherwise be considered as a match for ridesharing with the driver; one or more individual users the driver would like to directly invite to be passengers in a rideshare with the driver; a location from which the driver plans to depart when driving to the event; an earliest time the user is willing to depart when driving to the event; a time the driver plans to return after the event; a maximum distance (e.g., total distance, distance away from a direct route to the event, etc.) the driver is willing to drive in picking up passengers and driving to the event; particular cities, neighborhoods, zip codes, or other geographic limitations in which the user is willing to drive in picking up passengers and driving to the event; a cost or contribution amount for each passenger; and/or other preferences related to driving to the event. Exemplary selections of a set of one or more users within the social network that should see the invitation to rideshare utilize social graph 200 described above. For example, a driver may indicate that only friends/first degree connections that are going to the event are to see the rideshare invitation or otherwise be considered in determining rideshare matches. Alternatively, a driver may select a subset of friends/first degree connections, friends of friends/second degree connections, all users invited to/viewing the invitation, another grouping of users, or directly select one or more individual users. As discussed above, in one embodiment, event module 129 stores the ridesharing information in ridesharing store 144.

If the user does not plan to drive, at block 325, event module 129 optionally determines if the user would like to find a ride with a user planning to drive or take public transit. For example, in response to receiving a selection or other input indicating that the use intends to attend the event but not drive, event module 129 presents options or otherwise requests input as to how the user would like to travel to the event.

If the user input indicates that the user would like to find a ride with a user planning to drive (or if block 325 is omitted), at block 330, event module 129 optionally receives ridesharing information for the user as a passenger. Similar to the ridesharing information described above, in one embodiment, the user input indicates one or more of the following: if a particular set of users within the social network should see a request to drive the passenger or otherwise be considered as a match for ridesharing with the passenger, one or more individual users the passenger would like to directly request to be a driver in a rideshare with the passenger, a location from which the passenger plans to depart when travelling to the event, an earliest time the passenger is willing to depart when travelling to the event, a time the passenger plans to return after the event, a cost or contribution amount for the passenger is willing to pay, and/or other preferences related to the rideshare. Exemplary selections of a set of one or more users within the social network that should see a request to rideshare utilize social graph 200 described above. For example, a passenger may indicate that only friends/first degree connections that are going to the event are to see the rideshare request or otherwise be considered in determining rideshare matches. Alternatively, a passenger may select a subset of friends/first degree connections, friends of friends/second degree connections, all users invited to/viewing the invitation, another grouping of users, or directly select one or more individual users. As discussed above, in one embodiment, event module 129 stores the ridesharing information in ridesharing store 144.

If the user input indicates that the user would like to take some form of transit (e.g., a train, bus, taxi or similar service, etc.), at block 335, event module 129 receives ridesharing information for the user as a transit passenger. Similar to the ridesharing information described above, in one embodiment, the user input indicates one or more of the following: if a particular set of users within the social network should see a request to rideshare via transit/travel together or otherwise be considered as a match for ridesharing with the transit passenger, one or more individual users the transit passenger would like to request to join in the transit rideshare with the passenger, a location from which the transit passenger plans to depart when driving to the event, an earliest time the transit passenger is willing to depart when travelling to the event, a time the transit passenger plans to return after the event, a cost or contribution amount for the passenger is willing to pay, and/or other preferences related to the rideshare. Exemplary selections of a set of one or more users within the social network that should see a request to rideshare utilize social graph 200 described above. For example, a passenger may indicate that only friends/first degree connections that are going to the event are to see the rideshare request or otherwise be considered in determining rideshare matches. Alternatively, a passenger may select a subset of friends/first degree connections, friends of friends/second degree connections, all users invited to/viewing the invitation, another grouping of users, or directly select one or more individual users. Additionally, the transit passenger may specify a particular transit identifier (bus line, train number, car service, etc.) as the mode of transportation to be shared. As discussed above, in one embodiment, event module 129 stores the ridesharing information in ridesharing store 144.

At block 340, event module 129 determines and presents any potential ridesharing matches based upon the received ridesharing information and/or user profile information. In one embodiment, the driver is presented with the option of selecting passengers. For example, a driver may be presented with one or more users that are within the driver-specified set of users, have indicated that they are looking for a ride to the event, and, if applicable, have provided rideshare information or have user profile information that satisfies one or more of the location, distance, departure time, return time, or other ridesharing characteristics received from the driver. In one embodiment, a passenger is presented with the option of selecting a driver. For example, a passenger may be presented with one or more potential drivers that are within the passenger-specified set of users, have indicated that they are looking for a passenger to the event, and, if applicable, have provided rideshare information or have user profile information that satisfies one or more of the location, distance, departure time, return time, or other ridesharing characteristics received from the passenger.

In one embodiment, event module 129 receives ridesharing information from both users of a potential rideshare match. In such an embodiment, event module 129 selects matches in which the ridesharing information is satisfied for both users. For example, a driver may indicate a willingness to only have passengers that are first degree connections while a passenger may indicate a willingness to be paired with one or more users that are either first or second degree connections. In determining matches, event module 129 would not present the driver to the passenger (or vice versa) due to the driver's preference for only first degree connections as passengers.

In one embodiment, users seeking to share/have company on transit are similarly matched based upon received ridesharing information. For example, two users that indicated that they would be taking the same train line within the same window of time to reach the event may be presented to one another as potential travel companions.

In one embodiment, event module 129 presents potential matches to a user with an indication of other passengers/travel companions that have selected each potential match. For example, a driver may be presented to a potential passenger along with other passengers that plan to ride in the driver's vehicle. Similarly, a potential transit travel companion may be presented with other transit passengers that plan to ride with the potential transit travel companion. As a result, the user is able to determine if they are comfortable with other users in the rideshare.

At block 345, event module 129 receives a selection of a potential match. For example, similar to the other selections/inputs described herein, user 102A clicks on a selectable user interface object displayed by application 105A to join a rideshare with another user and user device 104A transmits the selection to social networking system 130. In one embodiment, multiple matches are selected. For example, a driver may select multiple passengers.

At block 350, event module 129 transmits a notification to the selected user(s). Event module 129 generates a message, email, or other form of notification to alert the user of the selection. In one embodiment, the selected user(s) are presented with an option to confirm or reject the selection.

At block 355, event module 129 utilizes the ridesharing information to present a user with an advertisement. For example, event module 129 may utilize the location of the event and information of which user is driving to present an advertisement to the driver for a parking garage near the event.

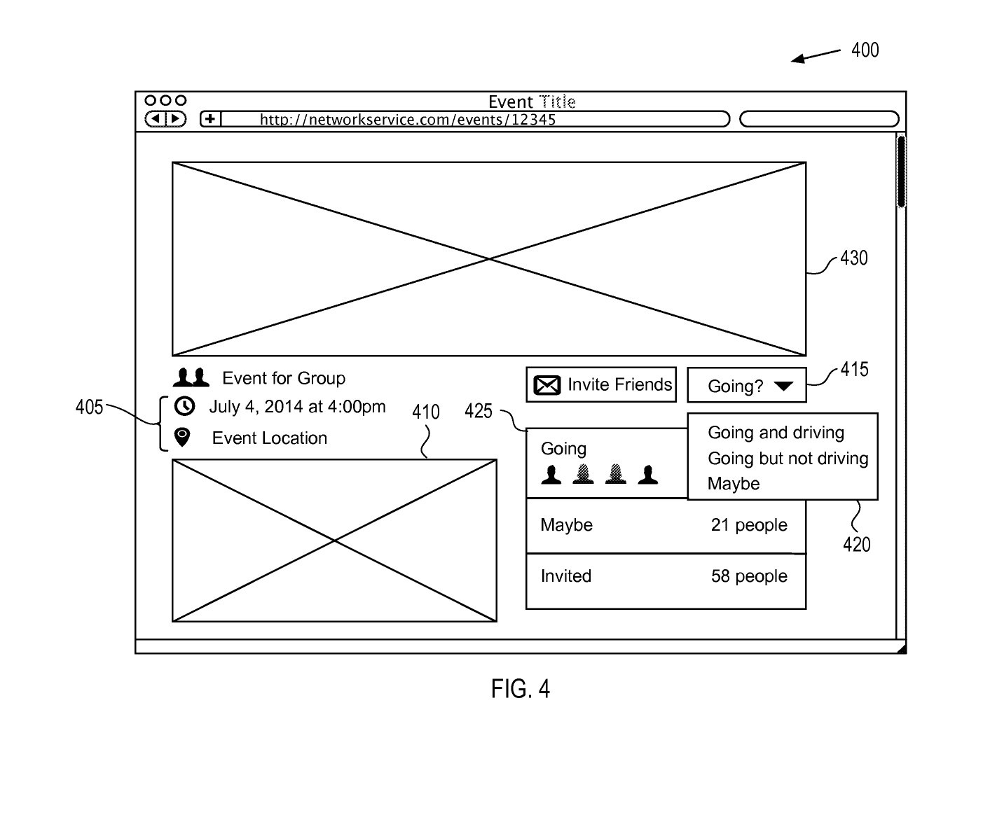

FIG. 4 is an exemplary user interface 400 illustrating an event and options for users to indicate intentions to attend and drive to an event or attend and not drive to the event. User interface 400 includes event description 405, a date and time for the event a location of the event. User interface 400 further includes map 410 displaying a map view of the event location. In one embodiment, map 410 is interactive an enables the user to plan a route or otherwise obtain directions to the event (e.g., by using a mapping API, launching a mapping application, redirecting a user to a mapping website, etc.).

User interface 400 further includes attendance user interface element 415. Selection of attendance user interface element 415 triggers drop down menu 420. Drop down menu 420 presents selectable options for the user to indicate whether the user intends to attend the event and drive to the event or the user intends to attend the event and not drive to the event.

User interface 400 may also include additional description, images, or other event information. For example, user interface 400 includes an indication or listing 425 of users that have confirmed their intention to attend the event, users that are unsure if they will attend the event, and users that have been invited to the event. User interface 400 further includes image 430, selected by event organizer or otherwise associated with the event.

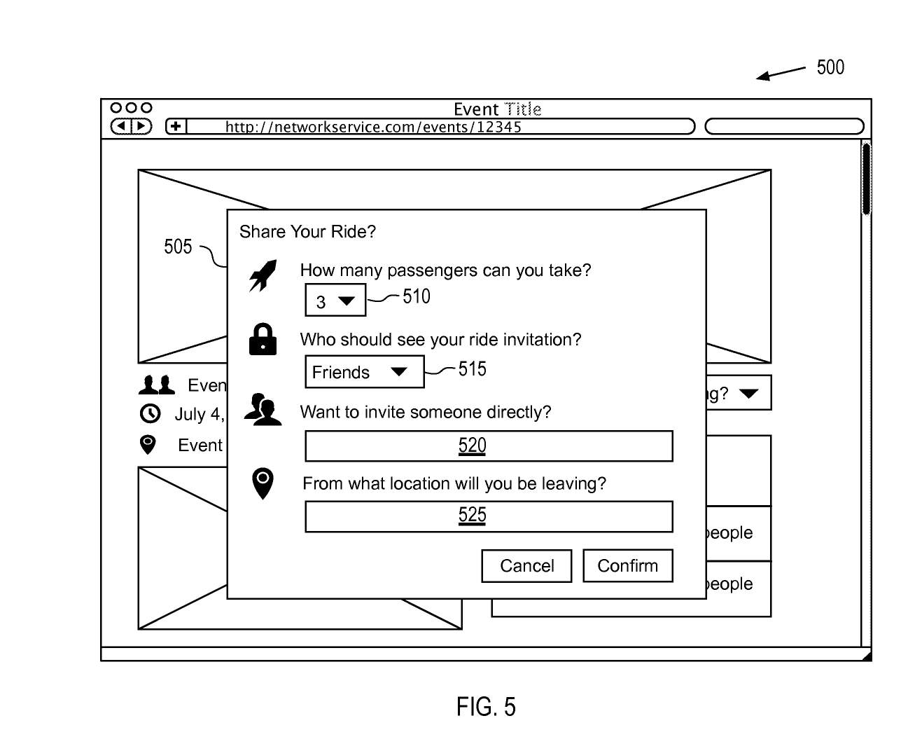

FIG. 5 is an exemplary user interface 500 illustrating form 505 to receive ridesharing information from a driver. For example, form 505 includes drop down menus 510-515 with selectable options for a number of passengers the driver is willing to take or the set of users (e.g., based upon social graph connections) that are able to see a ridesharing invitation or otherwise be matched with the driver. Additionally, form 505 includes input boxes 520-525 for the driver to enter individual users to be directly invited to the rideshare and the driver's planned departure location. As set forth in the examples above, form 505 may include additional fields for the driver to provide ridesharing information. A similar form may be used to collect ridesharing information from a user seeking a driver or planning to take transit.

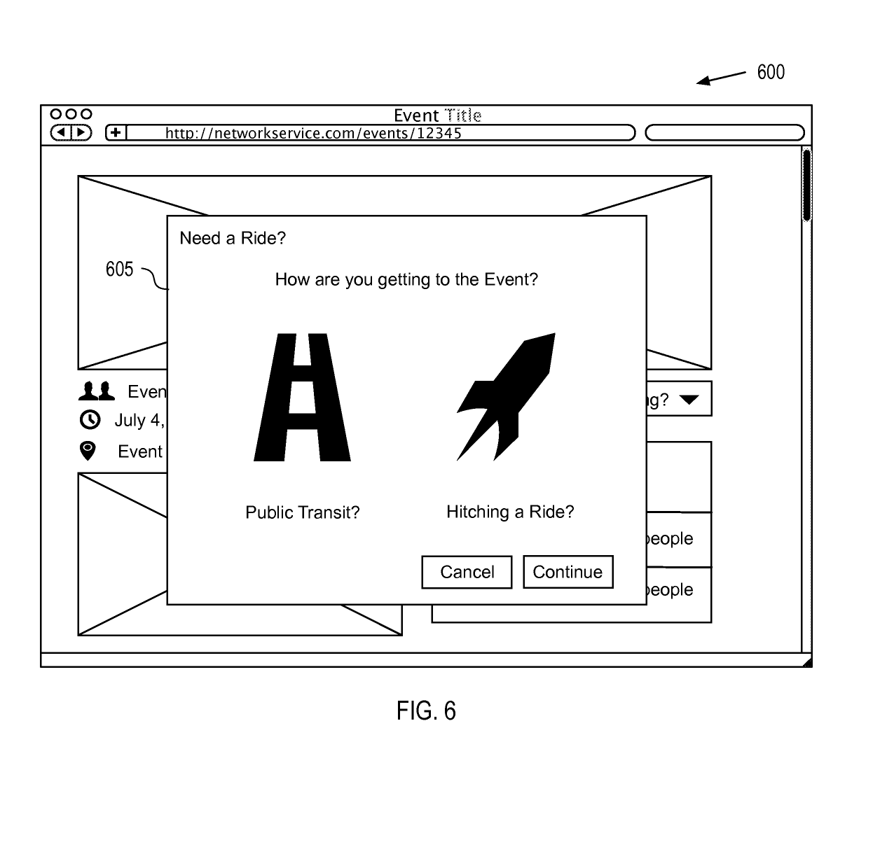

FIG. 6 is an exemplary user interface 600 illustrating form 605 to receive an indication of whether a non-driving user intends to take a form of transit or is seeking to rideshare with a driver attending the event. While form 605 refers to public transit, embodiments include private driving services, walking, biking, and other forms of transit. For example, event module 129 may utilize ridesharing information to pair two users that plan to ride bikes to the event so that they may ride together.

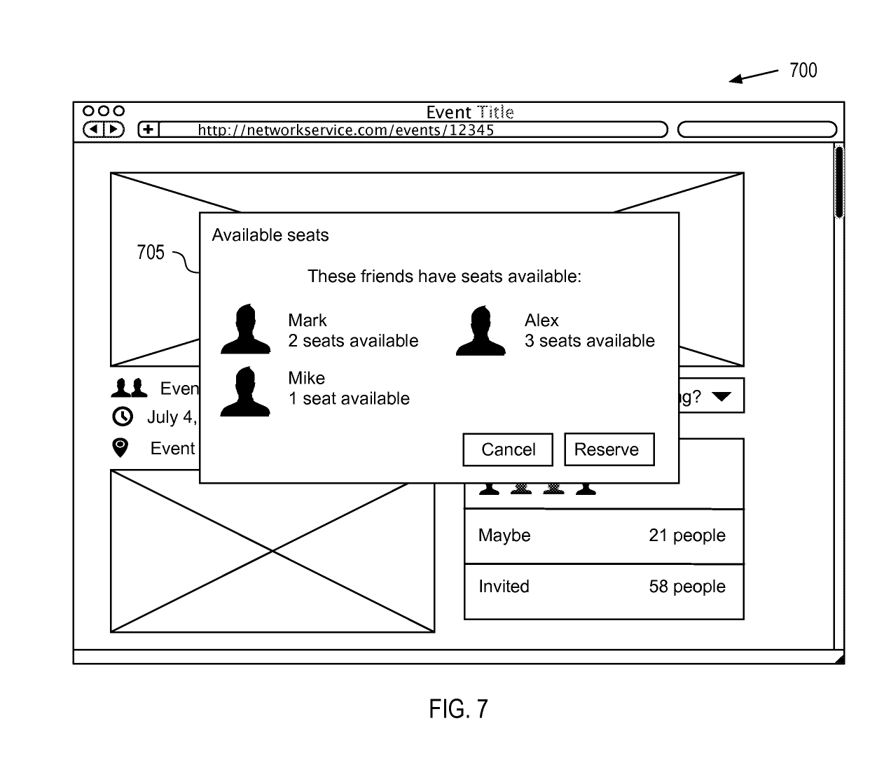

FIG. 7 is an exemplary user interface 700 illustrating determined matches 705 for a user seeking to be a passenger in a driver's vehicle. As described above, potential drivers may be selected based upon received ridesharing information from one or more users. Determined matches 705 are presented along with a number of available seats in each vehicle. In one embodiment, determined matches 705 further present other users riding as passengers in the corresponding vehicles (e.g., in response to selecting a particular driver).

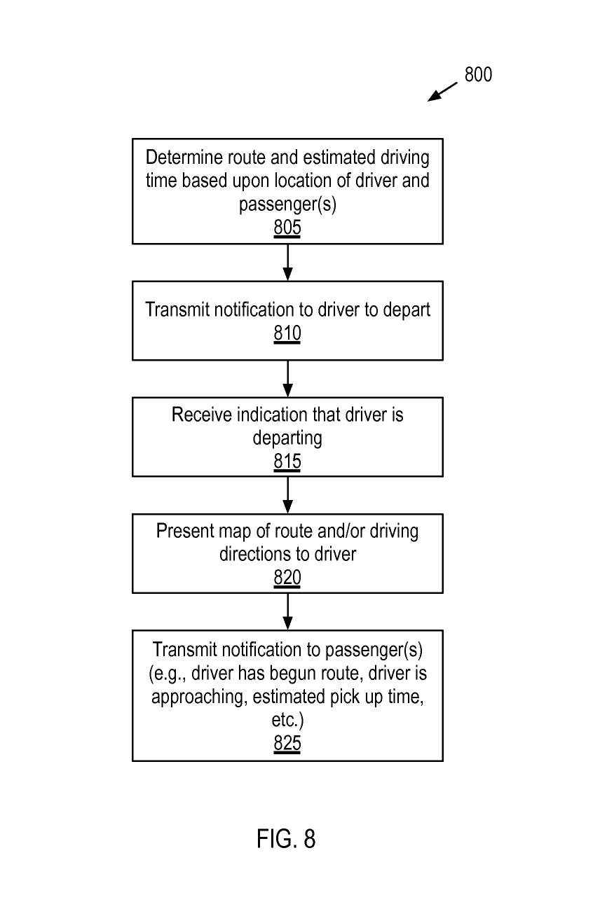

FIG. 8 is a flow chart illustrating another exemplary method 800 to facilitate event-based ridesharing. At block 805, event module 129 determines a route for the driver and an estimated driving time based upon locations of the driver and passenger(s). For example, event module 129 determines the route (e.g., using a map application API) based upon one or more of the following: departure locations provided by a user, a home or work location associated with a user profile, an estimated location based upon a history of user activity, and/or a location provided by the user device (e.g., global positioning satellite (GPS) location, estimated location based upon a user's network connection, etc.). With each stop to pick up the one or more passengers and the final destination of the event location, a route is determined to facilitate the rideshare. In one embodiment, event module 129 determines the route in response to all available seats in the driver's vehicle being filled by passengers.

In determining the route, event module 129 also determines an estimated driving time for the route. As a result, at block 810, event module 129 is able to provide the driver with an alert to start driving or start driving within a period of time. For example, if the determined route is estimated to take thirty minutes, event module 129 may alert the user forty five minutes prior to the event start time to provide the driver with the estimated thirty minutes and an additional fifteen minutes buffer to pick up the one or more passengers and arrive at the event on time. In one embodiment, the driver configures an amount of time in addition to the estimated driving time to use in determining when to alert the driver to begin the route. In yet another embodiment, the alert is presented to the user at a default or user-configured amount of time prior to the event, with or without consideration of the estimated drive time.

In one embodiment, the alert causes the driver's user device 104 to display a message or other notification that enables the user to open an application 105 and/or view the event and ridesharing information. For example, opening the application 105 in response to the alert may cause event module 129 to present a graphical user interface to the user that includes the event description, an indication of the passengers the driver is driving to the event, a map of the event, and/or a user interface object enabling the driver to indicate when departing to pick up the one or more passengers and proceed to the event.

At block 815, event module 129 receives an indication that the driver is departing to pick up the one or more passengers and proceed to the event. For example, the driver may interact with the user interface object presented in the user interface described above.

In one embodiment, event module 129 updates the determined route map and estimated travel time in response to receiving the indication that the driver is departing. In another embodiment, the determination of the route and estimated travel time described above is not performed until event module 129 receives the indication that the driver is departing.

At block 820, event module 129 presents the driver with a map of the determined route and/or driving directions based upon the determined route. For example, event module 129 may present the route map from the driver's departure location to each passenger and the event location in response to receiving the indication that the driver is departing.

At block 825, event module 129 transmits a notification to one or more passengers. For example, event module 129 may notify a passenger when the driver is departing, when the driver is within a threshold distance of the passenger, when the driver has picked up a previous passenger in the route, and/or when the driver is estimated to arrive to pick up the passenger. In one embodiment, users consistently share location information with social networking system 130. For example, user device 104A may be a GPS-enabled device that transmits location information to social networking system 130 in the background. As a result, event module 129 is able to compare the user's location to the determined route and/or determine if two users are travelling together as indicated by both users transmitting the same locations as they move. In one embodiment, one or more notifications are generated in response to one or more of the following: determining that the driver's current location has changed from the departure location, is a threshold distance away from the departure location, is the same as a pick up location within the route, is within a threshold distance of a pick up location within the route, is the same as a current location of a passenger, and/or is within a threshold distance of the current location of a passenger.

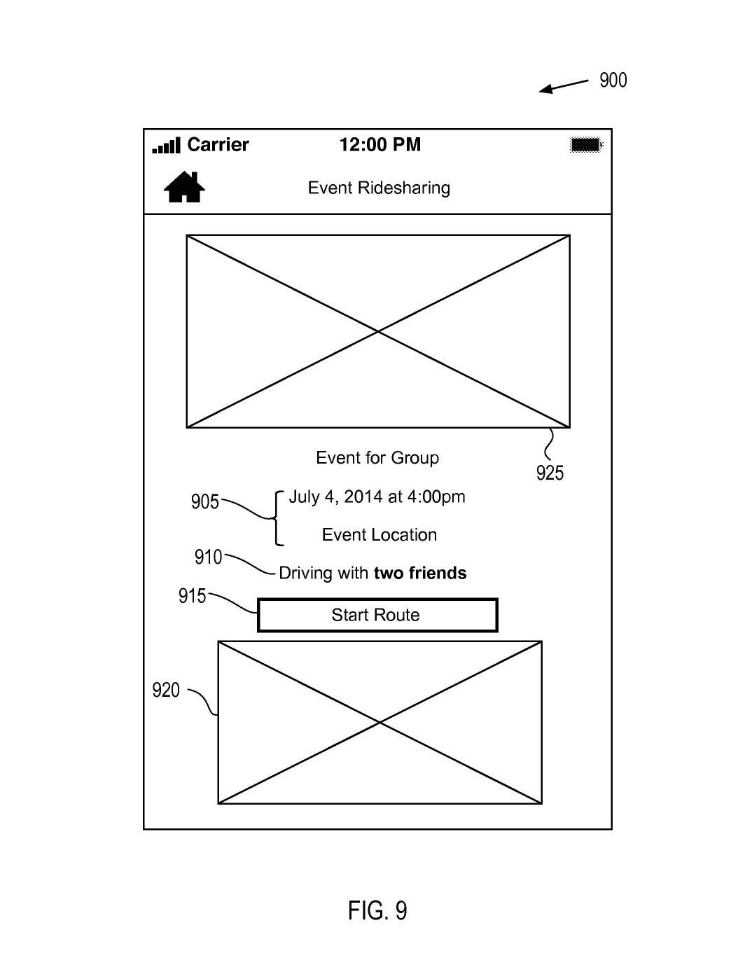

FIG. 9 is an exemplary user interface 900 to enable a driver to indicate a departure to pick up one or more passengers. In one embodiment, event module 129 presents user interface 900 to the driver upon opening the application 105 in response to the alert described above. User interface 900 includes a description of the event 905, e.g., the time and location of the event.

User interface 900 further includes an indication 910 of the passengers the driver is driving to the event. As illustrated, user interface includes an indication of the number of passengers. Alternatively, or additionally (e.g., by selecting the indication 910, swiping at least one portion of the user interface 900 in one direction or another, etc.), user interface 900 displays the names and/or images of the passengers.

User interface 900 further includes a user interface element 915 to enable a driver to indicate the driver's departure to pick up one or more passengers. For example, user selection of user interface element 915 (or a similar input) may cause event module 129 to present the driver with a map of the determined route and/or driving directions and/or alert one or more passengers that the driver is departing as described above.

User interface 900 may also include additional description, images, or other event information. For example, user interface 900 includes map 920 of the location of the event and image 925 associated with the event.

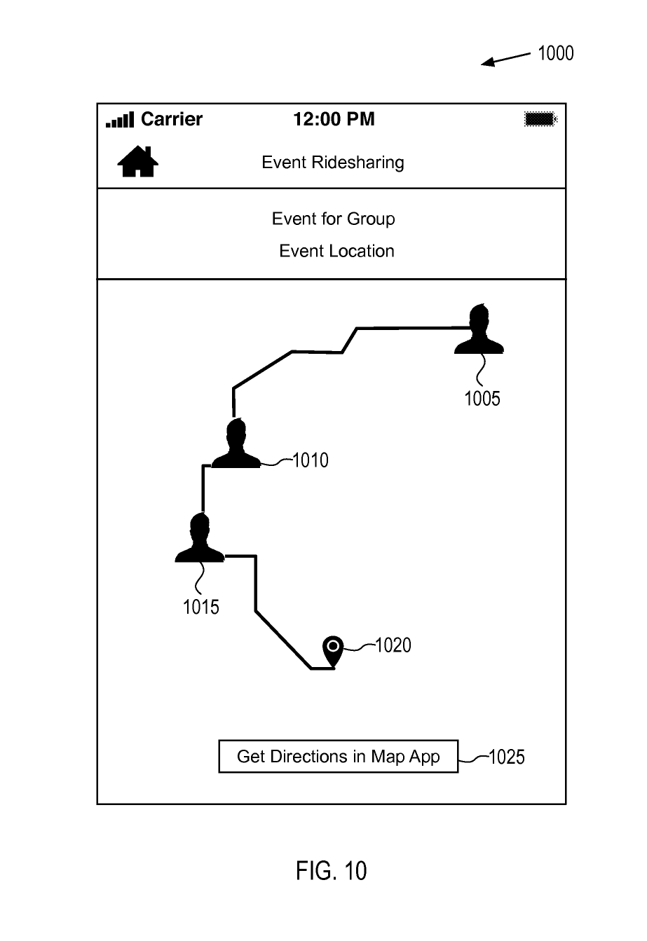

FIG. 10 is an exemplary user interface 1000 illustrating a route map presented to the driver. For example, user interface 1000 may be presented to the driver in response to receiving the indication the driver's departure described above. The route map displayed within user interface 1000 includes representations of the driver's location 1005, passenger locations 1010-1015, and event location 1020, as well as the route between each. User interface 1000 further includes a user interface element to enable the user to open the route in a map application, e.g., to enable an interactive route map and/or driving directions.

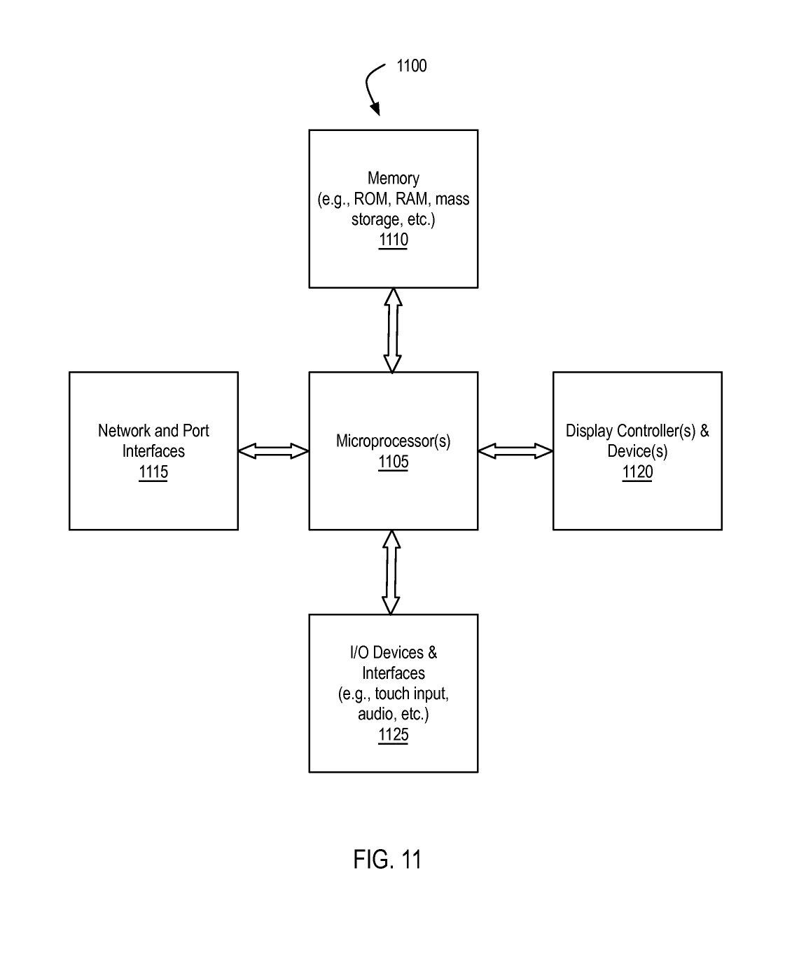

FIG. 11 illustrates, in block diagram form, an exemplary processing system 1100 to facilitate event-based ridesharing. Data processing system 1100 includes one or more microprocessors 1105 and connected system components (e.g., multiple connected chips). Alternatively, data processing system 1100 is a system on a chip.

Data processing system 1100 includes memory 1110, which is coupled to microprocessor(s) 1105. Memory 1110 may be used for storing data, metadata, and programs for execution by the microprocessor(s) 1105. For example, memory 1110 may include one or more of the data stores 101 and/or may store modules described herein. Memory 1110 may include one or more of volatile and non-volatile memories, such as Random Access Memory (“RAM”), Read Only Memory (“ROM”), a solid state disk (“SSD”), Flash, Phase Change Memory (“PCM”), or other types of data storage. Memory 1110 may be internal or distributed memory.

Data processing system 1100 includes network and port interfaces 1115, such as a port, connector for a dock, or a connector for a USB interface, FireWire, Thunderbolt, Ethernet, Fibre Channel, etc. to connect the system 1100 with another device, external component, or a network. Exemplary network and port interfaces 1115 also include wireless transceivers, such as an IEEE 802.11 transceiver, an infrared transceiver, a Bluetooth transceiver, a wireless cellular telephony transceiver (e.g., 2G, 3G, 4G, etc.), or another wireless protocol to connect data processing system 1100 with another device, external component, or a network and receive stored instructions, data, tokens, etc.

Data processing system 1100 also includes display controller and display device 1120 and one or more input or output (“I/O”) devices and interfaces 1125. Display controller and display device 1120 provides a visual user interface for the user. I/O devices 1125 allow a user to provide input to, receive output from, and otherwise transfer data to and from the system. I/O devices 1125 may include a mouse, keypad or a keyboard, a touch panel or a multi-touch input panel, camera, optical scanner, audio input/output (e.g., microphone and/or a speaker), other known I/O devices or a combination of such I/O devices.

It will be appreciated that one or more buses, may be used to interconnect the various components shown in FIG. 11.

Data processing system 1100 is an exemplary representation of one or more of the user device 104, external server 115, and one or more components of social networking system 130, or modules thereof (e.g., event module 129), described above. Data processing system 1100 may be a personal computer, tablet-style device, a personal digital assistant (PDA), a cellular telephone with PDA-like functionality, a Wi-Fi based telephone, a handheld computer which includes a cellular telephone, a media player, an entertainment system, or devices which combine aspects or functions of these devices, such as a media player combined with a PDA and a cellular telephone in one device. In other embodiments, data processing system 1100 may be a network computer, server, or an embedded processing device within another device or consumer electronic product. As used herein, the terms computer, device, system, processing system, processing device, and “apparatus comprising a processing device” may be used interchangeably with data processing system 1100 and include the above-listed exemplary embodiments.

Additional components, not shown, may also be part of data processing system 1100, and, in certain embodiments, fewer components than that shown in FIG. 11 may also be used in data processing system 1100. It will be apparent from this description that aspects of the inventions may be embodied, at least in part, in software. That is, the computer-implemented method(s) 300 and 800 may be carried out in a computer system or other data processing system 1100 in response to its processor or processing system 1105 executing sequences of instructions contained in a memory, such as memory 1110 or other non-transitory machine-readable storage medium. The software may further be transmitted or received over a network (not shown) via network interface device 1115. In various embodiments, hardwired circuitry may be used in combination with the software instructions to implement the present embodiments. Thus, the techniques are not limited to any specific combination of hardware circuitry and software, or to any particular source for the instructions executed by data processing system 1100.

An article of manufacture may be used to store program code providing at least some of the functionality of the embodiments described above. Additionally, an article of manufacture may be used to store program code created using at least some of the functionality of the embodiments described above. An article of manufacture that stores program code may be embodied as, but is not limited to, one or more memories (e.g., one or more flash memories, random access memories—static, dynamic, or other), optical disks, CD-ROMs, DVD-ROMs, EPROMs, EEPROMs, magnetic or optical cards or other type of non-transitory machine-readable media suitable for storing electronic instructions. Additionally, embodiments of the invention may be implemented in, but not limited to, hardware or firmware utilizing an FPGA, ASIC, a processor, a computer, or a computer system including a network. Modules and components of hardware or software implementations can be divided or combined without significantly altering embodiments of the invention.

As detailed herein, some embodiments of a method; embodiments of a non-transitory computer-readable medium storing instructions which, when executed by one or more processors in a processing device, cause the processing device to perform a method; and embodiments of an apparatus comprising a processing device, wherein the processing device executes instructions that cause the apparatus to perform a method. The methods described herein include presenting, to a first user of a network service, a description of an event, a selectable option for the first user to indicate an intention to attend the event, and an indication of users of the network service that intend to attend the event; receiving an indication that the first user intends to attend the event; receiving a selection of a set of one or more users of the network service the first user is willing to take as passengers to the event; receiving an indication that a second user of the network service intends to attend the event; and presenting the first user as a potential driver to the second user in response to receiving the indication that the second user intends to attend the event and determining the second user is within the set of one or more users. Additionally, some embodiments of the method further include one or more of: 1) the determining the second user is within the set of one or more users including determining that the second user is a connected to the first user within a network service; 2) receiving a number of passengers the first user is willing to drive to the event, wherein the first user is presented as a potential driver to the second user in response to determining the number of passengers has yet to be reached; 3) presenting, to the second user, a name of another user that selected the first user as a driver to the event; 4) receiving a first location from which first user intends to depart when driving to the event; and receiving a second location from which second user intends to depart when traveling to the event, wherein the first user is presented as a potential driver to the second user in response to determining that first and second locations are within a threshold distance of one another; 5) the presenting the first user as a potential driver to the second user including presenting a location from which the first user intends to depart when driving to the event; 6) receiving an indication that a third user intends to attend the event; receiving an indication that the third user intends to take public transit to the event; receiving an indication that a fourth user intends to attend the event; receiving an indication that the fourth user intends to take public transit to the event; and presenting, to the fourth user, the third user as a potential travel companion in taking public transit to the event; 7) determining a location of the event and presenting an advertisement to the first user based upon the location of the event; 8) receiving an indication of first user beginning route to pick up the second user and drive to event; determining a current location of the first user and a current location of the second user; and presenting driving directions to first user to navigate from the current location of first user to the current location of second user and to the event; and/or 9) receiving an indication of the first user beginning a route to pick up the second user and drive to event; and transmitting a notification to the second user that the first user is beginning the route to pick up the second user and drive to event.

It will be evident that various modifications may be made thereto without departing from the broader spirit and scope of the invention as set forth in the following claims. For example, the methods described herein may be performed with fewer or more features/blocks or the features/blocks may be performed in differing orders. Additionally, the methods described herein may be repeated or performed in parallel with one another or in parallel with different instances of the same or similar methods.

What is claimed is:

1. A computer-implemented method comprising:
presenting, to a first user of a network service, a description of an event, a selectable option for the first user to indicate an intention to attend the event, and an indication of users of the network service that intend to attend the event;
receiving an indication that the first user intends to attend the event;
receiving a selection of a set of one or more users of the network service the first user is willing to take as passengers to the event;
receiving an indication that a second user of the network service intends to attend the event; and
presenting the first user as a potential driver to the second user in response to receiving the indication that the second user intends to attend the event and determining the second user is within the set of one or more users.

2. The computer-implemented method of claim 1, wherein determining the second user is within the set of one or more users includes determining that the second user is a connected to the first user within a network service.

3. The computer-implemented method of claim 1, further comprising:
receiving a number of passengers the first user is willing to drive to the event, wherein the first user is presented as a potential driver to the second user in response to determining the number of passengers has yet to be reached.

4. The computer-implemented method of claim 1, further comprising:
presenting, to the second user, a name of another user that selected the first user as a driver to the event.

5. The computer-implemented method of claim 1, further comprising:
receiving a first location from which first user intends to depart when driving to the event; and
receiving a second location from which second user intends to depart when traveling to the event, wherein the first user is presented as a potential driver to the second user in response to determining that first and second locations are within a threshold distance of one another.

6. The computer-implemented method of claim 1, wherein presenting the first user as a potential driver to the second user includes presenting a location from which the first user intends to depart when driving to the event.

7. The computer-implemented method of claim 1, further comprising:
receiving an indication that a third user intends to attend the event;
receiving an indication that the third user intends to take public transit to the event;
receiving an indication that a fourth user intends to attend the event;
receiving an indication that the fourth user intends to take public transit to the event; and
presenting, to the fourth user, the third user as a potential travel companion in taking public transit to the event.

8. The computer-implemented method of claim 1, further comprising:
determining a location of the event; and
presenting an advertisement to the first user based upon the location of the event.

9. The computer-implemented method of claim 1, further comprising:
receiving an indication of first user beginning route to pick up the second user and drive to event;
determining a current location of the first user and a current location of the second user; and
presenting driving directions to first user to navigate from the current location of first user to the current location of second user and to the event.

10. The computer-implemented method of claim 1, further comprising:
receiving an indication of the first user beginning a route to pick up the second user and drive to event; and
transmitting a notification to the second user that the first user is beginning the route to pick up the second user and drive to event.

11. A non-transitory computer-readable medium storing instructions which, when executed by one or more processors in a processing device, cause the processing device to perform a method comprising:
presenting, to a first user of a network service, a description of an event, a selectable option for the first user to indicate an intention to attend the event, and an indication of users of the network service that intend to attend the event;
receiving an indication that the first user intends to attend the event;
receiving a selection of a set of one or more users of the network service the first user is willing to take as passengers to the event;
receiving an indication that a second user of the network service intends to attend the event; and
presenting the first user as a potential driver to the second user in response to receiving the indication that the second user intends to attend the event and determining the second user is within the set of one or more users.

12. The non-transitory computer-readable medium of claim 11, wherein determining the second user is within the set of one or more users includes determining that the second user is a connected to the first user within a network service.

13. The non-transitory computer-readable medium of claim 11, the method further comprising:
receiving a number of passengers the first user is willing to drive to the event, wherein the first user is presented as a potential driver to the second user in response to determining the number of passengers has yet to be reached.

14. The non-transitory computer-readable medium of claim 11, the method further comprising:
presenting, to the second user, a name of another user that selected the first user as a driver to the event.

15. The non-transitory computer-readable medium of claim 11, the method further comprising:
receiving a first location from which first user intends to depart when driving to the event; and
receiving a second location from which second user intends to depart when traveling to the event, wherein the first user is presented as a potential driver to the second user in response to determining that first and second locations are within a threshold distance of one another.

16. The non-transitory computer-readable medium of claim 11, wherein presenting the first user as a potential driver to the second user includes presenting a location from which the first user intends to depart when driving to the event.

17. The non-transitory computer-readable medium of claim 11, the method further comprising:
receiving an indication that a third user intends to attend the event;
receiving an indication that the third user intends to take public transit to the event;
receiving an indication that a fourth user intends to attend the event;
receiving an indication that the fourth user intends to take public transit to the event; and
presenting, to the fourth user, the third user as a potential travel companion in taking public transit to the event.

18. The non-transitory computer-readable medium of claim 11, the method further comprising:
determining a location of the event; and
presenting an advertisement to the first user based upon the location of the event.

19. The non-transitory computer-readable medium of claim 11, the method further comprising:
receiving an indication of first user beginning route to pick up the second user and drive to event;
determining a current location of the first user and a current location of the second user; and
presenting driving directions to first user to navigate from the current location of first user to the current location of second user and to the event.

20. The non-transitory computer-readable medium of claim 11, the method further comprising:
receiving an indication of the first user beginning a route to pick up the second user and drive to event; and
transmitting a notification to the second user that the first user is beginning the route to pick up the second user and drive to event.
